(19) United States
(12) Patent Application Publication
(10) Pub. No.: US 2023/0062307 A1
(43) Pub. Date: Mar. 2, 2023

(54) SMART DOCUMENT MANAGEMENT

(71) Applicant: SAP SE, Walldorf (DE)

(72) Inventor: Hans-Martin Ramsl, Mannheim (DE)

(21) Appl. No.: 17/404,428

(22) Filed: Aug. 17, 2021

(51) Int. Cl. G06F 16/16; G06F 40/205; G06K 9/00; G06N 3/02

(52) U.S. Cl. CPC G06F 16/166; G06F 40/205; G06K 9/00442; G06N 3/02; G06K 2009/00489

(57) ABSTRACT

Files are automatically named based on their contents and metadata. Contents include words in a text file, text recognized using optical character recognition (OCR) in an image file, and objects recognized using object recognition in an image file. Metadata includes creation date, modification date, user owning the file, file type, and file extension. Multiple files may be processed. A file sorter may determine an order in which to process the multiple files. For example, smaller files may be processed first. In addition to using the words discussed above to name the file, the file may be tagged based on the contents of the file. A search function for files may search both names and tags to identify responsive files. Two or more files may be linked based on their contents or metadata.

### TECHNICAL FIELD

The subject matter disclosed herein generally relates to document management. Specifically, the present disclosure addresses systems and methods to automatically name and organize files in a file system.

### BACKGROUND

Users create documents and store them in a file system. Naming conventions and file organization are inconsistent between users and between files created by individual users. Due to low correlation between file names and file contents, users often open many files before finding a particular file of interest.

### BRIEF DESCRIPTION OF THE DRAWINGS

FIG. 1 is a network diagram illustrating an example network environment suitable for smart document management.

FIG. 2 is a block diagram of a file management server, suitable for copying and renaming files for smart document management.

FIG. 3 is a block diagram of an example neural network, suitable for use in generating names for files.

FIG. 4 is a block diagram of an example neural network, suitable for generating language embeddings for programming languages or natural languages.

FIG. 5 is a block diagram of an example user interface for smart document management.

FIG. 6 is an example image file, suitable for analysis by a trained machine learning model to generate a name for the file.

FIG. 7 is a flowchart illustrating operations of an example method suitable for naming an image file.

FIG. 8 is a flowchart illustrating operations of an example method suitable for naming a text file.

FIG. 9 is a flowchart illustrating operations of an example method suitable for linking files with similar topics.

FIG. 10 is a block diagram showing one example of a software architecture for a computing device.

FIG. 11 is a block diagram of a machine in the example form of a computer system within which instructions may be executed for causing the machine to perform any one or more of the methodologies discussed herein.

### DETAILED DESCRIPTION

Example methods and systems are directed to automatically naming files based on their contents and metadata. Words contained in a file may be used in the file name. If the file is an image file, optical character recognition (OCR) may be used to identify words in the file. If the file contains multiple words, the words may be ranked based on proximity to the beginning of the file, repetition within the file, or both. Words used in the file name may be selected based on the ranking. Object recognition may be applied to image files to identify depicted objects. The name of a depicted object may be used in the file name. File names may also be based on metadata such as creation date, modification date, user owning the file, file type, file extension, version, or any suitable combination thereof.

A user may identify multiple files to be named. For example, a folder or file system may be selected by a user or an administrator for processing. A file sorter may determine an order in which to process the multiple files. For example, smaller files may be processed first.

In addition to using the words discussed above to name the file, the file may be tagged based on the contents of the file. For example, the top-ranked word may be used to name the file and the top five words used to tag the file. A search function for files may search both names and tags to identify responsive files. Two or more files may be linked based on their contents or metadata. For example, a file containing an image of an invoice may be linked to a file containing a letter requesting the invoice based on a degree of similarity between the two files.

Currently, files are named by people in inconsistent manners or named by computers without being meaningful to people (e.g., using an alphanumeric sequence that is meaningful to the program that created the file, but not to a person reading the file name). By using the systems and methods described herein to rename files based on their contents, the users of the file system are better enabled to find the files they are looking for and to quickly understand the contents of files. As a result, the usability of the file system is improved. Additionally, search functionality of the file system is improved. These improvements reduce computing resources spent in finding files. For example, a user that is not sure which of several files is of interest may open several files, consider the contents, and close the files before finding the desired file. Using the systems and methods described herein, the useless processing of these files is avoided, saving processor cycles, power consumption, memory accesses, and/or network bandwidth.

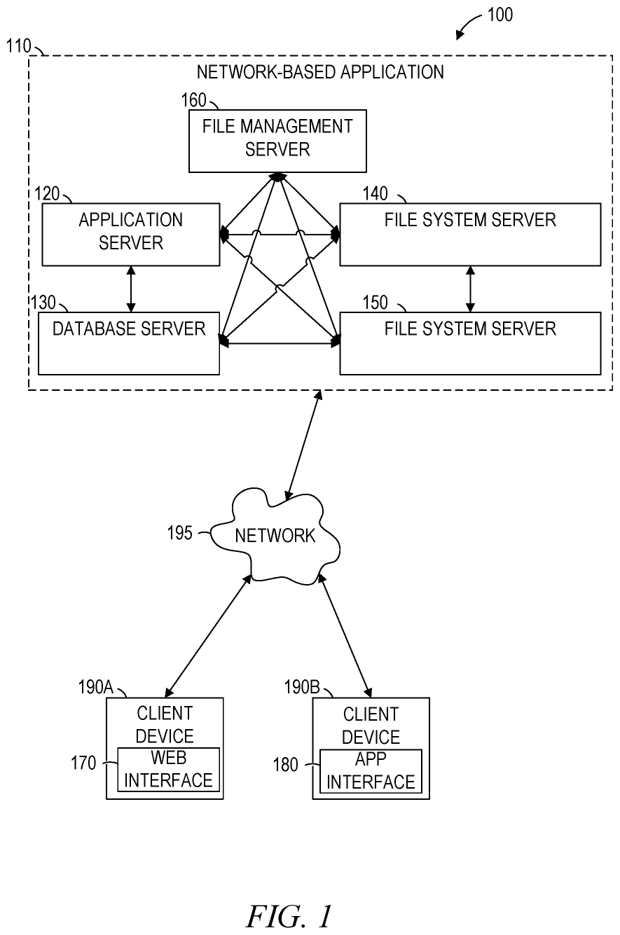

FIG. 1 is a network diagram illustrating an example network environment 100 suitable for smart document management. The network environment 100 includes a network-based application 110, client devices 190A and 190B, and a network 195. The network-based application 110 is provided by application server 120 in communication with a database server 130, file system servers 140 and 150, and a file management server 160. The application server 120 accesses application data (e.g., application data stored by the database server 130) to provide one or more applications to the client devices 190A and 190B via a web interface 170 or an application interface 180.

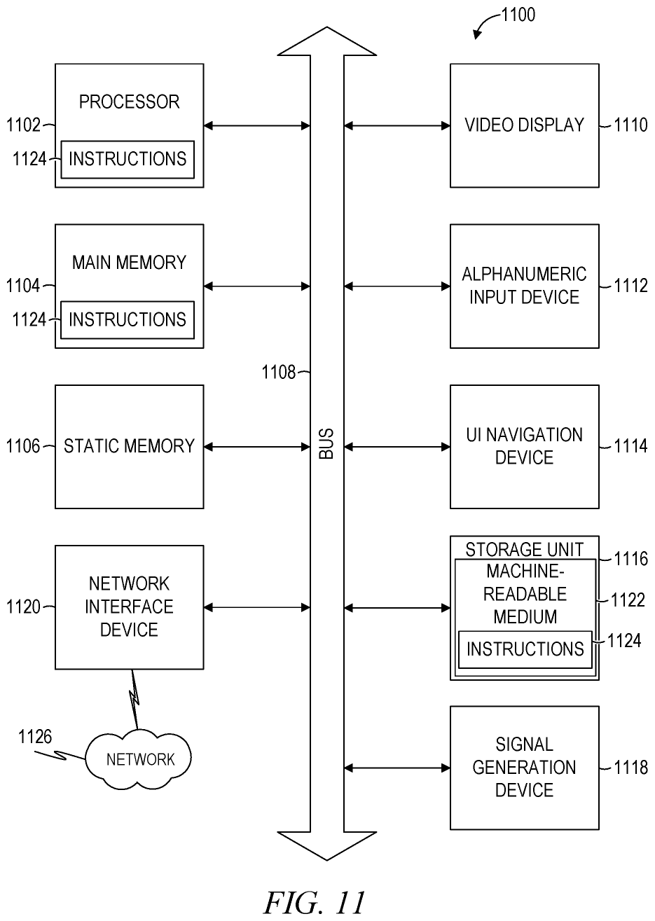

The application server 120, the database server 130, the file system servers 140 and 150, the file management server 160, and the client devices 190A and 190B may each be implemented in a computer system, in whole or in part, as described below with respect to FIG. 11. The client devices 190A and 190B may be referred to collectively as client devices 190 or generically as a client device 190.

Users of the network-based application 110 access files from the file system server 140. For example, each user may have a personal folder in which they can create, edit, and delete files. The files may include image files (e.g., graphics interchange files (GIFs), portable graphics format (PNG) files, or Joint Photographic Experts Group (JPEG) files), document files (e.g., Word files with extension .DOC or .DOCX or portable document format (PDF) files), spreadsheet files (e.g., Excel files, comma-separated value (CSV) files, or Open Document Format (ODF) files), and other types of files.

The file management server 160 accesses files from the file system server 140 and copies them to the file system server 150. The copied files may be renamed, reorganized, or both. For example, the files may be renamed so that the file names reflect the contents of the files. As another example, the files may be organized so that folders are created for topics and the files are placed in the corresponding folders. Additionally or alternatively, metadata of the files may be added or modified. For example, related files may be linked to make it easier to navigate from one file to the other.

To determine the topic of a file, words in the file may be detected and used to look up the topic from a database. Alternatively, a most common word in the file may be used as the topic of the file. A language embedder may be used to generate an embedding vector for the contents of the file. The generated embedding vector may be provided to a trained machine learning model as input, with the topic for the file provided as output. As used herein, “embedding” refers to the conversion of human-readable words (in a natural language or a programming language) into multidimensional vectors suitable for computer processing. The vectors may be of one hundred dimensions or more, and thus are not suitable for manual calculation. Training of the language embeddings may be supervised or unsupervised. Supervised training takes labeled data as input. Unsupervised training learns from unlabeled data.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 11. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The application server 120, the database server 130, the file system servers 140 and 150, the file management server 160, and the client devices 190A-190B are connected by the network 195. The network 195 may be any network that enables communication between or among machines, databases, and devices. Accordingly, the network 195 may be a wired network, a wireless network (e.g., a mobile or cellular network), or any suitable combination thereof. The network 195 may include one or more portions that constitute a private network, a public network (e.g., the Internet), or any suitable combination thereof.

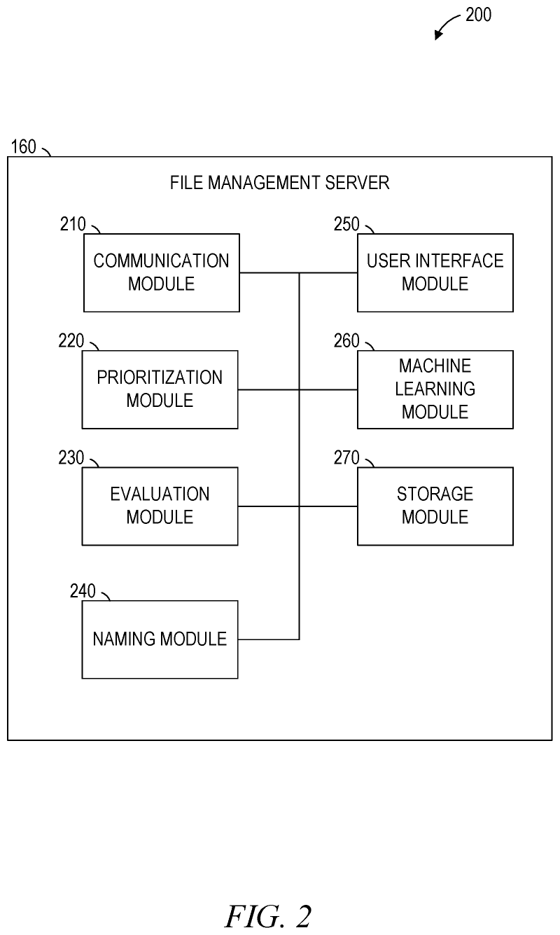

FIG. 2 is a block diagram of a file management server 160, suitable for copying and renaming files for smart document management. The file management server 160 is shown as including a communication module 210, a prioritization module 220, an evaluation module 230, a naming module 240, a user interface module 250, a machine learning module 260, and a storage module 270, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, modules described herein as being implemented within a single machine, database, or device may be distributed across multiple machines, databases, or devices.

The communication module 210 receives data sent to the file management server 160 and transmits data from the file management server 160. For example, the communication module 210 may receive, from the client device 190A or 190B, a request to process one or more folders on the file system server 140 to generate one or more folders on the file system server 150.

The prioritization module 220 prioritizes the files in the one or more folders to be processed. For example, smaller files may be given a higher priority than larger files. The processing time for a file may be proportional to the size of the file. Accordingly, prioritizing smaller files above larger files causes smaller files to be processed first, increasing the number of files that have been processed during the period of time in which only a portion of the files have been processed. As another example, user input may be received that indicates which files are to be prioritized. As still another example, metadata of the files may be used to prioritize the files. For example, in a folder containing email files, emails marked “urgent” may be processed before other emails, regardless of size.

The file management server 160 uses the evaluation module 230 to evaluate each file and generate data about the file to be used by the naming module 240. The evaluation module 230 may perform OCR or object recognition on an image file to determine words in the file or objects depicted in the file. Additionally or alternatively, the evaluation module 230 may access metadata for the file to determine a creation date, a modification date, a user account that owns the file, a type of the file, a version of the file, or any suitable combination thereof. The evaluation module 230 may use a text parser to identify words in a document file, use a filetype-specific parser to access text of a document file, or both.

The naming module 240 copies files from the file system server 140 to the file system server 150 and selects the names for the copied files based on data receive from the evaluation module 230. For example, files may be named with a date prefix in YYYY-MM-DD format, followed by a topic word or phrase. The date may be the creation date of the file, as determined from metadata for the file in the file system server 140. The topic word or phrase may be determined from the contents of the file.

A user interface for searching is provided by the file management server 160 using the user interface module 250. For example, a hypertext markup language (HTML) document may be generated by the user interface module 250, transmitted to a client device 190 by the communication module 210, and rendered on a display device of the client device 190 by a web browser executing on the client device 190. The user interface may comprise text fields, drop-down menus, and other inputs fields. The user interface may also comprise a progress report, show names and paths of original files, show names and paths of copied files, or any suitable combination thereof.

The machine learning module 260 trains machine learning models to perform various functions based on training data. For example, a machine learning model may be trained using input documents or images and output topics. This machine learning model is trained to determine a topic for an input file. Multiple machine learning models may be trained to determine topics for different types of files (e.g., image files and document files).

Trained machine learning models, search queries, search results, input files, output files, or any suitable combination thereof may be stored and accessed by the storage module 270. For example, local storage of the file management server 160, such as a hard drive, may be used. As another example, network storage may be accessed by the storage module 270 via the network 195.

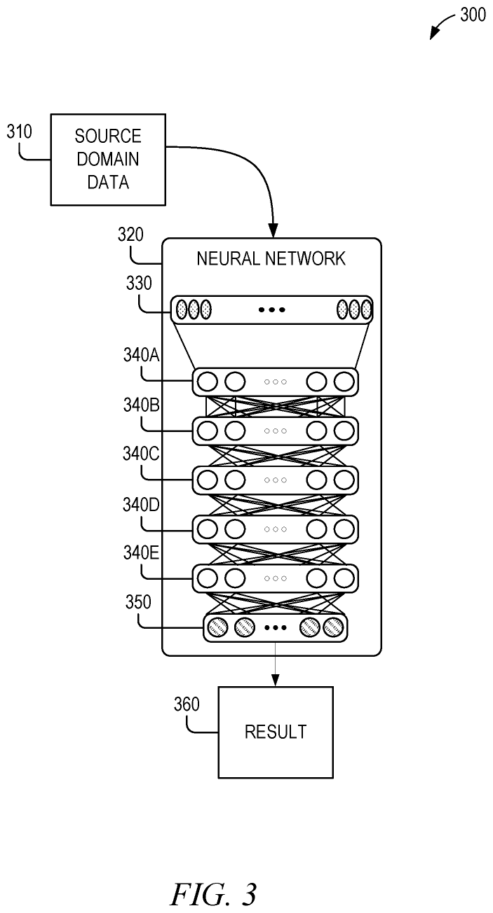

FIG. 3 illustrates the structure of an example neural network 320. The neural network 320 takes source domain data 310 as input, processes the source domain data 310 using the input layer 330; the intermediate, hidden layers 340A, 340B, 340C, 340D, and 340E; and the output layer 350 to generate a result 360.

A neural network, sometimes referred to as an artificial neural network, is a computing system based on consideration of biological neural networks of animal brains. Such systems progressively improve performance, which is referred to as learning, to perform tasks, typically without task-specific programming. For example, in image recognition, a neural network may be taught to identify images that contain an object by analyzing example images that have been tagged with a name for the object and, having learnt the object and name, may use the analytic results to identify the object in untagged images.

A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

Each of the layers 330-350 comprises one or more nodes (or “neurons”). The nodes of the neural network 320 are shown as circles or ovals in FIG. 3. Each node takes one or more input values, processes the input values using zero or more internal variables, and generates one or more output values. The inputs to the input layer 330 are values from the source domain data 310. The output of the output layer 340 is the result 360. The intermediate layers 340A-340E are referred to as “hidden” because they do not interact directly with either the input or the output, and are completely internal to the neural network 320. Though five hidden layers are shown in FIG. 3, more or fewer hidden layers may be used.

A model may be run against a training dataset for several epochs, in which the training dataset is repeatedly fed into the model to refine its results. In each epoch, the entire training dataset is used to train the model. Multiple epochs (e.g., iterations over the entire training dataset) may be used to train the model. The number of epochs may be 10, 100, 500, 1000, or another number. Within an epoch, one or more batches of the training dataset are used to train the model. Thus, the batch size ranges between 1 and the size of the training dataset while the number of epochs is any positive integer value. The model parameters are updated after each batch (e.g., using gradient descent).

In a supervised learning phase, a model is developed to predict the output for a given set of inputs, and is evaluated over several epochs to more reliably provide the output that is specified as corresponding to the given input for the greatest number of inputs for the training dataset. The training dataset comprises input examples with labeled outputs. For example, a user may label images based on their content and the labeled images used to train an image identifying model to generate the same labels.

For self-supervised learning, the training dataset comprises self-labeled input examples. For example, a set of color images could be automatically converted to black-and-white images. Each color image may be used as a “label” for the corresponding black-and-white image, and used to train a model that colorizes black-and-white images. This process is self-supervised because no additional information, outside of the original images, is used to generate the training dataset. Similarly, when text is provided by a user, one word in a sentence can be masked and the network trained to predict the masked word based on the remaining words.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. The finalized models may be evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusters is used to select a model that produces the clearest bounds for its clusters of data.

The neural network 320 may be a deep learning neural network, a deep convolutional neural network, a recurrent neural network, or another type of neural network. A neuron is an architectural element used in data processing and artificial intelligence, particularly machine learning. A neuron implements a transfer function by which a number of inputs are used to generate an output. The inputs may be weighted and summed, with the result compared to a threshold to determine if the neuron should generate an output signal (e.g., a 1) or not (e.g., a 0 output). Through the training of a neural network, the inputs of the component neurons are modified. One of skill in the art will appreciate that neurons and neural networks may be constructed programmatically (e.g., via software instructions) or via specialized hardware linking each neuron to form the neural network.

An example type of layer in the neural network 320 is a Long Short Term Memory (LSTM) layer. An LSTM layer includes several gates to handle input vectors (e.g., time-series data), a memory cell, and an output vector. The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

The structure of each layer may be predefined. For example, a convolution layer may contain small convolution kernels and their respective convolution parameters, and a summation layer may calculate the sum, or the weighted sum, of two or more values. Training assists in defining the weight coefficients for the summation.

One way to improve the performance of DNNs is to identify newer structures for the feature-extraction layers, and another way is by improving the way the parameters are identified at the different layers for accomplishing a desired task. For a given neural network, there may be millions of parameters to be optimized. Trying to optimize all these parameters from scratch may take hours, days, or even weeks, depending on the amount of computing resources available and the amount of data in the training set.

One of ordinary skill in the art will be familiar with several machine learning algorithms that may be applied with the present disclosure, including linear regression, random forests, decision tree learning, neural networks, deep neural networks, genetic or evolutionary algorithms, and the like.

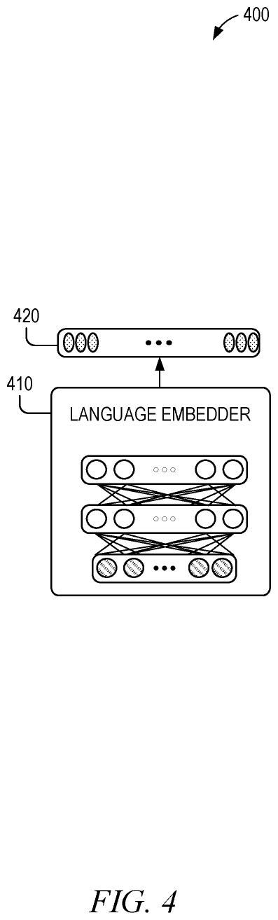

FIG. 4 is a block diagram of an example model architecture 400 for language embedding. The model architecture 400 includes a language embedder 410 and a resulting vector 420. The language embedder 410 is trained so that the distance (or loss) function for two related text strings is reduced or minimized. For example, synonymous natural language text or programming language text may be provided as inputs and the language embedder 410 trained to minimize the distance between the resulting vectors.

The specific architecture of the language embedder 410 may be chosen dependent on the type of input data for an embedding layer that is followed by some encoder architecture that creates a vector from the sequence. Embeddings and encoder parameters are shared between the text fields. In the simplest case the encoder stage is just an elementwise average of the token embeddings.

Alternatively, the encoding may include converting pairs of words of the text to bigram vectors and combining the bigram vectors to generate a vector for the text. For example, the text “function performs” may have a corresponding vector as a bigram, rather than two separate vectors for “function” and “performs” that are combined. The text “This function processes incoming emails to detect junk” may be stripped of articles and prepositions and converted to vectors for each of the bigrams “This function,” “function processes,” “processes incoming,” “incoming emails,” “emails detect,” and “detect junk.” The vector for a text string may be determined as an average of the bigram vectors for the bigrams in the text string.

In some example embodiments, a pre-trained vector embedding is used rather than training an embedding on a training set. For example, the doc2vec embedding may be used.

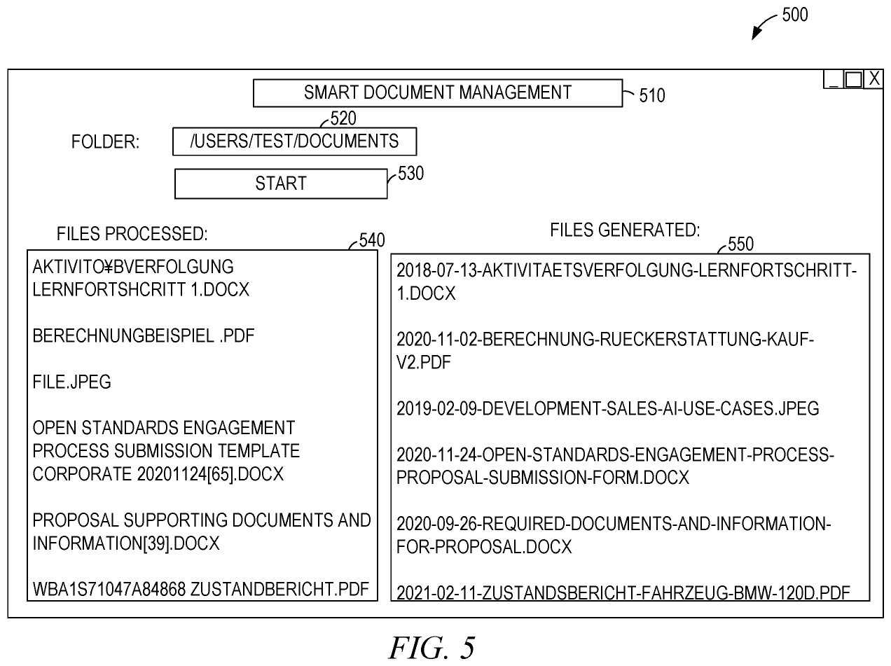

FIG. 5 is a block diagram of an example user interface 500 for smart document management. The user interface 500 includes a title 510, input field 520, button 530, and informational areas 540 and 550. The user interface 500 may be displayed on a display device of the client device 190A or 190B in response to a request from a user of the client device 190A or 190B. For example, a request may be received via a user interface, and transferred to the file management server 160 via the network 195. In response, the file management server 160 causes the client device 190A or 190B to display the user interface 500.

The title 510 indicates that the user interface 500 is for smart document management. The input field 520 allows the user to select a folder or to enter a path for a folder. Once the folder is selected, the file management server 160 detects a user interaction (e.g., a click or touch) with the button 530 and, in response, begins processing of the selected folder.

The informational area 540 shows the names of files processed by the file management server 160. The files generated by the file management server 160 are shown in the informational area 550. The first file in the informational area 540 includes the character “¥.” The corresponding first file in the informational area 550 has had the character removed. Removal of the character may be based on recognizing the character in a banned list of characters. Alternatively, removal of the character may be based on determining that the character is not in an approved list of characters. For example, characters 0-31 and 127 are control characters in the American Standard Code for Information Interchange (ASCII), and thus may be present in a banned list. Alternatively, the same result may be achieved by having characters 32-126 in an approved list. Using other character sets and applications, different banned and approved lists may be used. For example, characters in filenames may be limited to alphanumeric characters, “.”, and “-”.

Certain characters may be permitted to appear no more than a maximum number of times in a file name. For example, the “.” character, traditionally delimiting the filename prefix and the filename suffix, may be permitted to appear no more than once. Thus, each “.” except the last one may be replaced by another character, such as a dash (“-”). Other character conversions may also be performed. For example, vowels with umlauts may be replaced by the corresponding vowel without an umlaut. Checksums or hash values in file names may be recognized and preserved (e.g., based on formatting of the string containing the checksum or hash value or based on verification of the checksum or hash value by independent calculation). Additional modifications to the name of the first file include prepending a creation date in YYYY-MM-DD format. As can be seen by inspection of FIG. 5, the other files have been renamed so that the names indicate the creation date of each file and the contents of the file.

In the example of FIG. 5, the file of the first file collection named “BERECHNUNGBEISPIEL PDF” is renamed to “2020-11-02-BERECHNUNG-RUEKERSTATTUNG-KAUF-V2.PDF” when it is copied to the second file collection. The new file name includes a creation date, words determined based on the contents of the file, and a “V2” element that indicates that the file has a version number of 2. The version number may be accessed by the naming module 240 from metadata for the input file. A filetype-specific metadata parser may be used. For example, the file may be identified as a PDF file and a PDF-specific metadata parser used to extract the metadata. A different metadata parser may be used for each different file type (e.g., Word, GIF, and so on).

The generated files may be stored in the same directory structure as the input files, with a different root directory. For example, the generated files may be stored in a /users/test/documents folder of the file system server 150 and the input files may be stored in a /users/test/documents folder of the file system server 140. Alternatively, the generated files may be stored in an adjacent folder to the input folder. For example, the generated files may be stored in a /users/test/documents-managed folder of the file system server 140, adjacent to the input /users/test/documents folder on the same file system server 140.

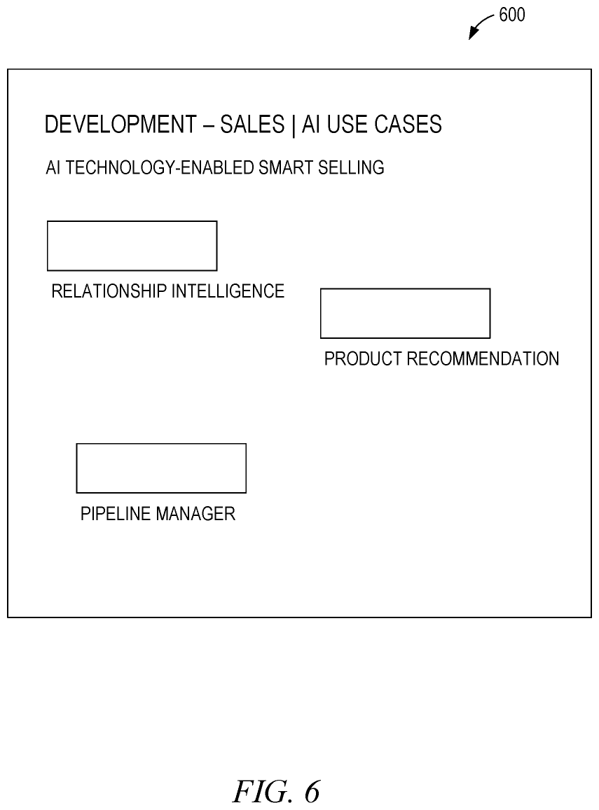

FIG. 6 is an example image file 600, suitable for analysis by a trained machine learning model to generate a name for the file. The image file 600 includes text and graphics (indicated by rectangles within the image). The evaluation module 230 may use OCR to extract the text from the image file 600. The graphics may be interpreted by the evaluation module 230 using an object recognition engine (e.g., a trained learning model). Based on text detected or objects recognized, the name of a file generated may be selected. For example, the image file 600 may be the input file “file.jpeg” shown in the informational area 540 of FIG. 5. The corresponding output file is “2019-02-09-DEVELOPMENT-SALES-AI-USE-CASES.JPEG.” Thus, the output file has been renamed based on the creation date of “file.jpeg” and text detected in the image file 600.

The OCR application may provide the OCR output in JavaScript Object Notation (JSON) format. An example JSON object is below.

```
{
  “filename_old”: “WBA1S710407A84868_SAP Zustandsbericht.pdf”,
  “filename_new”: “”,
  “ocr”: “Keine Gwähr auf Vollständigkeit und ...;”
}
```

Each file may have a corresponding JSON object that is updated during processing. For example, the JSON object above may be updated to include object recognition data generated by an object recognition engine.

```
{
  “filename_old”: “WBA1S710407A84868_SAP Zustandsbericht.pdf”,
  “filename_new”: “”,
  “ocr”: “Keine Gewähr auf Vollständigkeit und ...;”
  “objects”: {
    “object1”: “car”,
    “object2”: “rim”,
    “object3”: “wheel”,
    “object4”: “speedometer”,
    “object5”: “wheel”
  }
}
```

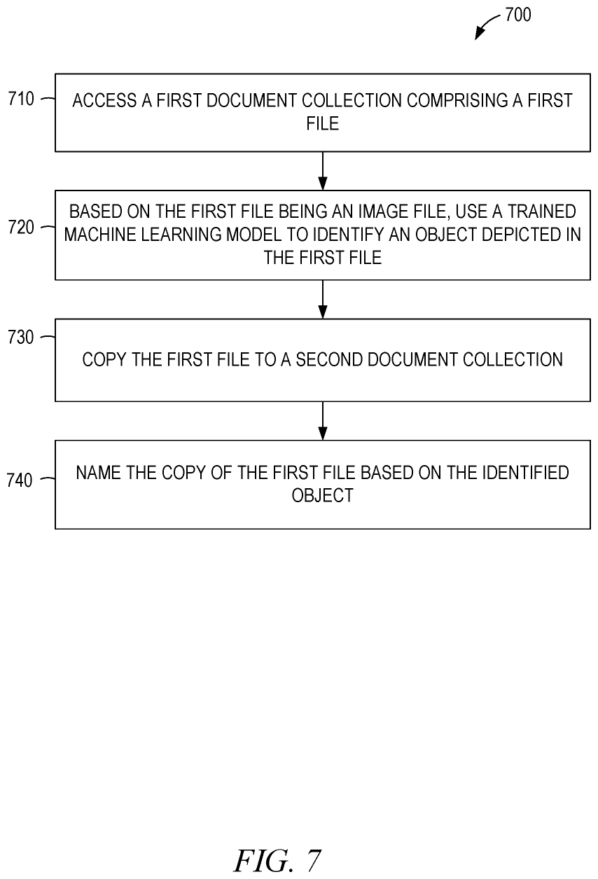

FIG. 7 is a flowchart illustrating operations of an example method 700 suitable for naming an image file. The method 700 includes operations 710, 720, 730, and 740. By way of example and not limitation, the method 700 may be performed by the file management server 160 of FIG. 1, using the modules, databases, structures, and images shown in FIGS. 2-6.

In operation 710, the prioritization module 220 of the file management server 160 accesses a first document collection comprising a first file. For example, the user interface 500 of FIG. 5 may be used to receive an identification of a folder storing the first document collection. As shown in FIG. 5, the first document collection includes FILE.JPEG. The prioritization module 220 may determine an order in which the documents of the first document collection are processed. For example, the order of the copying may be based on file sizes of the files of the first document collection, such that smaller files are copied before larger files. As another example, documents may be classified according to their file size, with a first class for files up to 10 MB, a second class for files larger than 10 MB and no greater than 100 MB, and a third class for files larger than 100 MB. Different or additional classes may be used (e.g., a fourth class for files larger than third class files and no greater than 200 MB, a fifth class for files larger than fourth class files and no greater than 1 GB, a sixth class for files larger than fifth class files and no greater than 10 GB, and so on). Files in the first class may be processed before files in the second class, which are processed before files in the third class. Within each class, files may be processed in order of file size or according to different criteria. For example, files may be processed in alphabetical order according to their file names in the first document collection, processed according to file type (e.g., with all GIF files processed before any JPEG files), processed according to date of last access (e.g., most-recently accessed files processed first), processed according to frequency of access (e.g., most-frequently accessed files processed first), or any suitable combination thereof.

Accessing the file may include error detection and correction. For example, a checksum value for a file may be transmitted from the file system server 140 hosting the first document collection to the file management server 160 before transmitting the file. After the file management server 160 receives the file, the file management server 160 independently calculates the checksum value from the received file and compares the calculated checksum value with the received checksum value. If the two checksum values match, processing of the file continues. Otherwise, an error condition is detected and the file management server 160 requests the file system server 140 to send the file again, the file management server 160 causes a user interface to be presented on a user interface to inform a user of the error, further processing of the file is skipped, or any suitable combination thereof.

The evaluation module 230 determines, based on the type of the first file, how to obtain information about the first file to be used by the naming module 240 to name a copy of the first file for smart document management. In the example of the method 700, based on the first file being an image file, the evaluation module 230 uses a trained machine learning model to identify an object depicted in the first file (operation 720). For example, the image file may be an image of an orange and the trained machine learning model may generate an output of “fruit,” or “orange.”

In operation 730, the naming module 240 copies the first file to a second document collection. For example, the user interface 500 may be modified to allow a user to provide a path to the second document collection. As another example, the second document collection may be located on a different server than the first file collection and placed in a directory determined based on the location of the first file collection, the user requesting the processing of the first file collection, or both. The first file is copied from the first document collection to the second document collection.

The naming module 240, in operation 740, names the copy of the first file based on the identified object. For example, the input file “FILE.JPEG” may be renamed to “ORANGE.JPEG” when copied. The renaming of operation 740 may occur as part of the copying of operation 730, before the copying of operation 730, or after the copying of operation 730. The name of the copy of the first file may include additional information (e.g., a creation date, as in “2021-07-14 ORANGE.JPEG”). The name of the copy of the first file may be based on the name of the first file in the first document collection. For example, the file name of the copy may comprise a word in the name of the file in the first document collection, a name of an object identified through object recognition of an image contained in the file, a word contained in text of the file, a word contained in an image in the file recognized via OCR, metadata for the file, or any suitable combination thereof.

Thus, by use of the method 700, the name of an image file is modified to identify an object depicted in the image file, making it easier for a user to determine if the file is of interest before opening the file. As a result, the frequency with which the file is opened erroneously is reduced, improving the usefulness of the file system and saving system resources such as processor cycles, power, memory accesses, network data transfers, and the like.

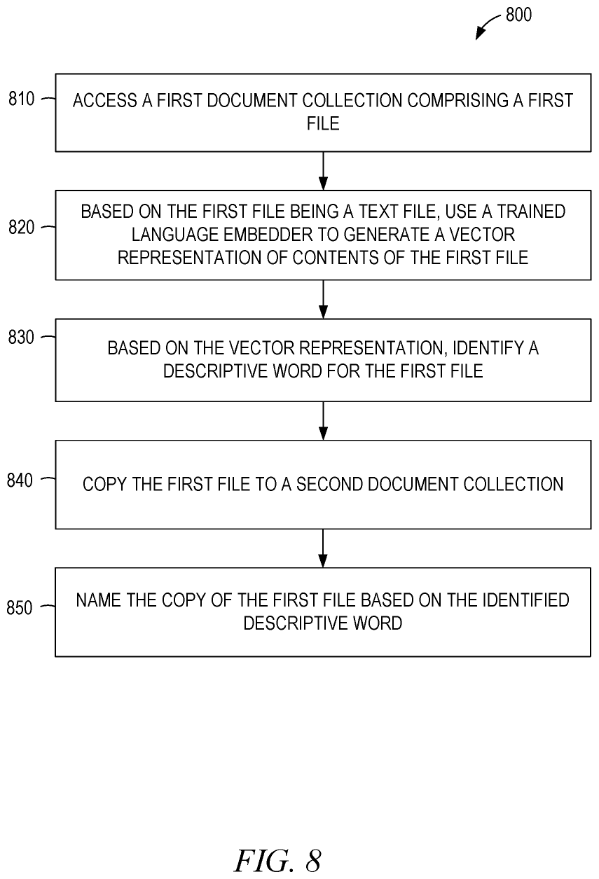

FIG. 8 is a flowchart illustrating operations of an example method 800 suitable for naming a text file. The method 800 includes operations 810, 820, 830, 840, and 850. By way of example and not limitation, the method 800 may be performed by the file management server 160 of FIG. 1, using the modules, databases, structures, and images shown in FIGS. 2-6.

In operation 810, the prioritization module 220 of the file management server 160 accesses a first document collection comprising a first file. For example, as in the method 700, the user interface 500 of FIG. 5 may be used to receive an identification of a folder storing the first document collection. As shown in FIG. 5, the first document collection includes OPEN STANDARDS ENGAGEMENT PROCESS SUBMISSION TEMPLATE CORPORATE 20201124[65].DOCX. The prioritization module 220 may determine an order in which the documents of the first document collection are processed.

The evaluation module 230 determines, based on the type of the first file, how to obtain information about the first file to be used by the naming module 240 to name a copy of the first file for smart document management. In the example of the method 800, based on the first file being a text file, the evaluation module 230 uses a trained language embedder to generate a vector representation of contents of the first file (operation 820). For example, the language embedder 410 may be used to covert the words in the first file to vectors. The vectors of the first file may be summed or averaged to generate a vector representation for the first file.

In operation 830, the evaluation module 230 identifies, based on the vector representation, a descriptive word for the first file. For example, a reverse lookup may be used to determine a word in a dictionary that has the closest vector to the vector representation for the first file (e.g., as determined by Euclidian distance) and the determined word may be used as the descriptive word.

The naming module 240, in operation 840, copies the first file to a second document collection. For example, the user interface 500 may be modified to allow a user to provide a path to the second document collection. As another example, the second document collection may be located on a different server than the first file collection and placed in a directory determined based on the location of the first file collection, the user requesting the processing of the first file collection, or both. The first file is copied from the first document collection to the second document collection.

The naming module 240 names the copy of the first file based on the identified descriptive word (operation 850). For example, the identified descriptive word may be “form” and the input file “OPEN STANDARDS ENGAGEMENT PROCESS SUBMISSION TEMPLATE CORPORATE 20201124[65].DOCX” may be renamed to “2020-11-24-OPEN-STANDARDS-ENGAGEMENT-PROCESS-PROPOSAL-SUBMISSION-FORM.DOCX” when copied. The renaming of operation 850 may occur as part of the copying of operation 840, before the copying of operation 840, or after the copying of operation 840.

Thus, by use of the method 800, the name of a text file is modified to include a descriptive word determined from the contents of the text file, making it easier for a user to determine if the file is of interest before opening the file. As a result, the frequency with which the file is opened erroneously is reduced, improving the usefulness of the file system and saving system resources such as processor cycles, power, memory accesses, network data transfers, and the like.

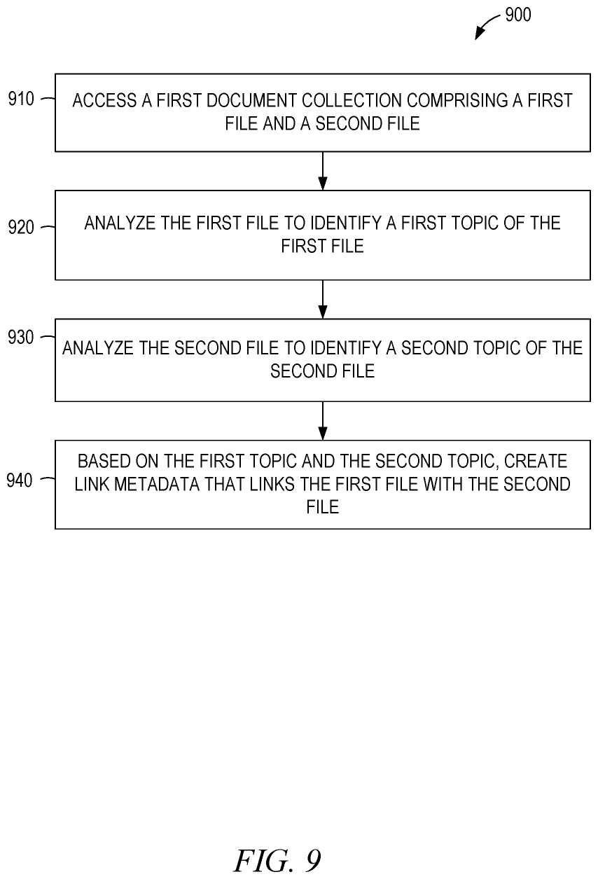

FIG. 9 is a flowchart illustrating operations of an example method 900 suitable for linking files with similar topics. The method 900 includes operations 910, 920, 930, and 940. By way of example and not limitation, the method 900 may be performed by the file management server 160 of FIG. 1, using the modules, databases, structures, and user interfaces shown in FIGS. 2-5.

In operation 910, the file management server 160 accesses a first document collection comprising a first file and a second file. For example, as in the methods 700 and 800, the user interface 500 of FIG. 5 may be used to receive an identification of a folder storing the first document collection. As shown in FIG. 5, the first document collection includes several files.

The evaluation module 230, in operations 920 and 930, analyzes the first file to identify a first topic of the first file and analyzes the second file to identify a second topic of the second file. For example, operations 820 and 830 of the method 800 may be used to identify a descriptive word of a text file, which may be taken as a topic of the text file. As another example, operation 720 of the method 700 may be used to identify an object depicted in an image file, which may be taken as a topic of the image file.

In operation 940, based on the first topic and the second topic, the evaluation module 230 creates link metadata that links the first file with the second file. For example, the two files may be linked based on their topics being the same. As another example, embedding vectors for the topics may be determined using the language embedder 410 and the two files linked if the topic vectors have a distance measure (e.g., a Euclidean distance) that is below a predetermined threshold (e.g., 0.1).

The link metadata may be used in a user interface to allow a user to quickly navigate from the first file to the second file or vice versa. For example, right-clicking on a filename in the informational area 550 of the user interface 500 may present a list of files linked to the selected filename. Selecting a file from the list may open the linked file.

In addition to or as an alternative to linking files, each file may be tagged based on the contents of the file. For example, the top-ranked word may be used to name the file and the top five words used to tag the file (e.g., by adding words to metadata of the file). A search function for files may search both names and tags to identify responsive files. The linking of files may be based on the tags for the files. For example, files that share two or more tags may be automatically linked.

In view of the above described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a method comprising: accessing, by one or more processors, a first document collection comprising a first file; based on the first file being an image file, using a trained machine learning model to identify an object depicted in the first file; copying the first file to a second document collection; and naming the copy of the first file based on the identified object.

In Example 2, the subject matter of Example 1 includes, wherein: the first document collection comprises a second file; and the method further comprises: based on the second file being a text file, using a language embedder to generate a vector representation of contents of the second file; based on the vector representation of the contents of the second file, identifying a descriptive word for the second file; copying the second file to the second document collection; and naming the copy of the second file based on the identified descriptive word.

In Example 3, the subject matter of Example 2 includes, based on the identified object depicted in the first file and the descriptive word for the second file, creating link metadata that links the copy of the first file with the copy of the second file.

In Example 4, the subject matter of Examples 1-3 includes, based on the first file being an image file, using optical character recognition to identify text depicted in the first file; using a language embedder to generate a vector representation of the identified text; and based on the vector representation of the identified text, identifying a descriptive word for the first file; wherein the naming of the copy of the first file is further based on the identified descriptive word.

In Example 5, the subject matter of Examples 1-4 includes, based on metadata for the first file, identifying a creation date of the first file; wherein the naming of the copy of the first file is further based on the identified creation date.

In Example 6, the subject matter of Examples 1-5 includes, wherein: the copying of the first file to the second document collection is performed as part of copying all files of the first document collection to the second document collection, an order of the copying being based on file sizes of the files of the first document collection.

In Example 7, the subject matter of Examples 1-6 includes, wherein: the naming of the copy of the first file is further based on a name of the first file in the first document collection.

In Example 8, the subject matter of Example 7 includes determining that the name of the first file in the first document collection includes a character in a banned list of characters; and wherein the naming of the copy of the first file comprises excluding the character.

In Example 9, the subject matter of Examples 1-8 includes, based on metadata for the first file, identifying a version number of the first file; wherein the naming of the copy of the first file is further based on the identified version number.

Example 10 is a system comprising: a memory that stores instructions; and one or more processors configured by the instructions to perform operations comprising: accessing a first document collection comprising a first file; based on the first file being an image file, using a trained machine learning model to identify an object depicted in the first file; copying the first file to a second document collection; and naming the copy of the first file based on the identified object.

In Example 11, the subject matter of Example 10 includes, wherein: the first document collection comprises a second file; and the operations further comprise: based on the second file being a text file, using a language embedder to generate a vector representation of contents of the second file; based on the vector representation of the contents of the second file, identifying a descriptive word for the second file; copying the second file to the second document collection; and naming the copy of the second file based on the identified descriptive word.

In Example 12, the subject matter of Example 11 includes, wherein the operations further comprise: based on the identified object depicted in the first file and the descriptive word for the second file, creating link metadata that links the copy of the first file with the copy of the second file.

In Example 13, the subject matter of Examples 10-12 includes, wherein the operations further comprise: based on the first file being an image file, using optical character recognition to identify text depicted in the first file; using a language embedder to generate a vector representation of the identified text; and based on the vector representation of the identified text, identifying a descriptive word for the first file; wherein the naming of the copy of the first file is further based on the identified descriptive word.

In Example 14, the subject matter of Examples 10-13 includes, wherein the operations further comprise: based on metadata for the first file, identifying a creation date of the first file; wherein the naming of the copy of the first file is further based on the identified creation date.

In Example 15, the subject matter of Examples 10-14 includes, wherein: the copying of the first file to the second document collection is performed as part of copying all files of the first document collection to the second document collection, an order of the copying being based on file sizes of the files of the first document collection.

In Example 16, the subject matter of Examples 10-15 includes, wherein: the naming of the copy of the first file is further based on a name of the first file in the first document collection.

In Example 17, the subject matter of Example 16 includes, wherein the operations further comprise: determining that the name of the first file in the first document collection includes a character in a banned list of characters; and wherein the naming of the copy of the first file comprises excluding the character.

Example 18 is a non-transitory computer-readable medium that stores instructions that, when executed by one or more processors, cause the one or more processors to perform operations comprising: accessing a first document collection comprising a first file; based on the first file being an image file, using a trained machine learning model to identify an object depicted in the first file; copying the first file to a second document collection; and naming the copy of the first file based on the identified object.

In Example 19, the subject matter of Example 18 includes, wherein: the first document collection comprises a second file; and the operations further comprise: based on the second file being a text file, using a language embedder to generate a vector representation of contents of the second file; based on the vector representation of the contents of the second file, identifying a descriptive word for the second file; copying the second file to the second document collection; and naming the copy of the second file based on the identified descriptive word.

In Example 20, the subject matter of Example 19 includes, wherein the operations further comprise: based on the identified object depicted in the first file and the descriptive word for the second file, creating link metadata that links the copy of the first file with the copy of the second file.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

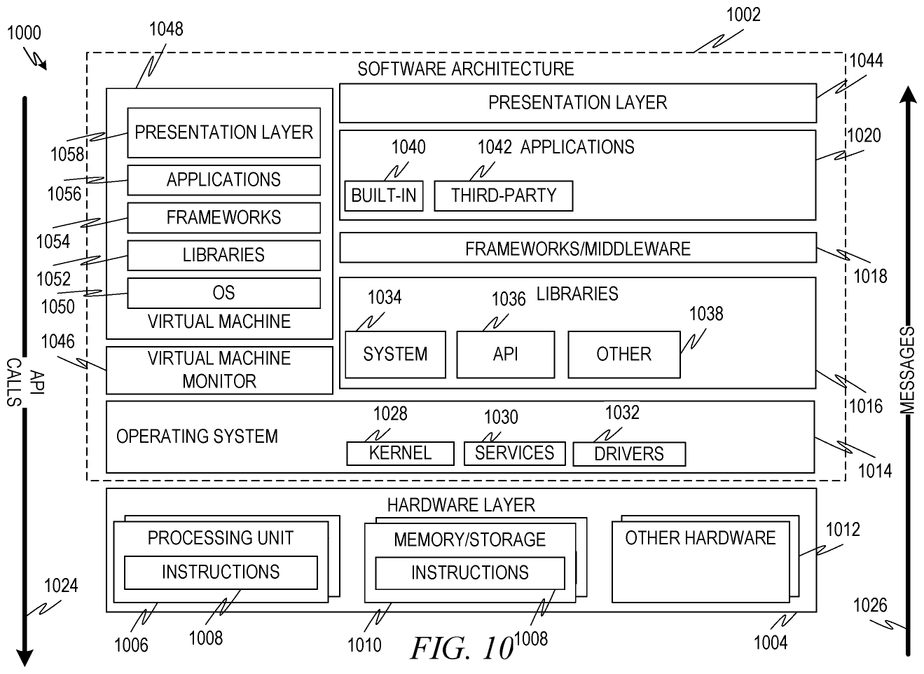

FIG. 10 is a block diagram 1000 showing one example of a software architecture 1002 for a computing device. The architecture 1002 may be used in conjunction with various hardware architectures, for example, as described herein. FIG. 10 is merely a non-limiting example of a software architecture and many other architectures may be implemented to facilitate the functionality described herein. A representative hardware layer 1004 is illustrated and can represent, for example, any of the above referenced computing devices. In some examples, the hardware layer 1004 may be implemented according to the architecture of the computer system of FIG. 10.

The representative hardware layer 1004 comprises one or more processing units 1006 having associated executable instructions 1008. Executable instructions 1008 represent the executable instructions of the software architecture 1002, including implementation of the methods, modules, subsystems, and components, and so forth described herein and may also include memory and/or storage modules 1010, which also have executable instructions 1008. Hardware layer 1004 may also comprise other hardware as indicated by other hardware 1012 which represents any other hardware of the hardware layer 1004, such as the other hardware illustrated as part of the software architecture 1002.

In the example architecture of FIG. 10, the software architecture 1002 may be conceptualized as a stack of layers where each layer provides particular functionality. For example, the software architecture 1002 may include layers such as an operating system 1014, libraries 1016, frameworks/middleware 1018, applications 1020, and presentation layer 1044. Operationally, the applications 1020 and/or other components within the layers may invoke application programming interface (API) calls 1024 through the software stack and access a response, returned values, and so forth illustrated as messages 1026 in response to the API calls 1024. The layers illustrated are representative in nature and not all software architectures have all layers. For example, some mobile or special purpose operating systems may not provide a frameworks/middleware 1018 layer, while others may provide such a layer. Other software architectures may include additional or different layers.

The operating system 1014 may manage hardware resources and provide common services. The operating system 1014 may include, for example, a kernel 1028, services 1030, and drivers 1032. The kernel 1028 may act as an abstraction layer between the hardware and the other software layers. For example, the kernel 1028 may be responsible for memory management, processor management (e.g., scheduling), component management, networking, security settings, and so on. The services 1030 may provide other common services for the other software layers. In some examples, the services 1030 include an interrupt service. The interrupt service may detect the receipt of an interrupt and, in response, cause the architecture 1002 to pause its current processing and execute an interrupt service routine (ISR) when an interrupt is accessed.

The drivers 1032 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1016 may provide a common infrastructure that may be utilized by the applications 1020 and/or other components and/or layers. The libraries 1016 typically provide functionality that allows other software modules to perform tasks in an easier fashion than to interface directly with the underlying operating system 1014 functionality (e.g., kernel 1028, services 1030 and/or drivers 1032). The libraries 1016 may include system libraries 1034 (e.g., C standard library) that may provide functions such as memory allocation functions, string manipulation functions, mathematic functions, and the like. In addition, the libraries 1016 may include API libraries 1036 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 1016 may also include a wide variety of other libraries 1038 to provide many other APIs to the applications 1020 and other software components/modules.

The frameworks/middleware 1018 may provide a higher-level common infrastructure that may be utilized by the applications 1020 and/or other software components/modules. For example, the frameworks/middleware 1018 may provide various graphic user interface (GUI) functions, high-level resource management, high-level location services, and so forth. The frameworks/middleware 1018 may provide a broad spectrum of other APIs that may be utilized by the applications 1020 and/or other software components/modules, some of which may be specific to a particular operating system or platform.

The applications 1020 include built-in applications 1040 and/or third-party applications 1042. Examples of representative built-in applications 1040 may include, but are not limited to, a contacts application, a browser application, a book reader application, a location application, a media application, a messaging application, and/or a game application. Third-party applications 1042 may include any of the built-in applications as well as a broad assortment of other applications. In a specific example, the third-party application 1042 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 1042 may invoke the API calls 1024 provided by the mobile operating system such as operating system 1014 to facilitate functionality described herein.

The applications 1020 may utilize built in operating system functions (e.g., kernel 1028, services 1030 and/or drivers 1032), libraries (e.g., system libraries 1034, API libraries 1036, and other libraries 1038), frameworks/middleware 1018 to create user interfaces to interact with users of the system. Alternatively, or additionally, in some systems, interactions with a user may occur through a presentation layer, such as presentation layer 1044. In these systems, the application/module “logic” can be separated from the aspects of the application/module that interact with a user.

Some software architectures utilize virtual machines. In the example of FIG. 10, this is illustrated by virtual machine 1048. A virtual machine creates a software environment where applications/modules can execute as if they were executing on a hardware computing device. A virtual machine is hosted by a host operating system (operating system 1014) and typically, although not always, has a virtual machine monitor 1046, which manages the operation of the virtual machine 1048 as well as the interface with the host operating system (i.e., operating system 1014). A software architecture executes within the virtual machine 1048 such as an operating system 1050, libraries 1052, frameworks/middleware 1054, applications 1056 and/or presentation layer 1058. These layers of software architecture executing within the virtual machine 1048 can be the same as corresponding layers previously described or may be different.

### Modules, Components and Logic

A computer system may include logic, components, modules, mechanisms, or any suitable combination thereof. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

### Example Machine Architecture and Machine-Readable Medium

FIG. 11 is a block diagram of a machine in the example form of a computer system 1100 within which instructions 1124 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU), or both), a main memory 1104, and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard or a touch-sensitive display screen), a user interface (UI) navigation (or cursor control) device 1114 (e.g., a mouse), a storage unit 1116, a signal generation device 1118 (e.g., a speaker), and a network interface device 1120.

### Machine-Readable Medium

The storage unit 1116 includes a machine-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104 and/or within the processor 1102 during execution thereof by the computer system 1100, with the main memory 1104 and the processor 1102 also constituting machine-readable media 1122.

While the machine-readable medium 1122 is shown in FIG. 11 to be a single medium, the term “machine-readable medium” may include a single medium or multiple media (e.g., a centralized or distributed database, and/or associated caches and servers) that store the one or more instructions 1124 or data structures. The term “machine-readable medium” shall also be taken to include any tangible medium that is capable of storing, encoding, or carrying instructions 1124 for execution by the machine and that cause the machine to perform any one or more of the methodologies of the present disclosure, or that is capable of storing, encoding, or carrying data structures utilized by or associated with such instructions 1124. The term “machine-readable medium” shall accordingly be taken to include, but not be limited to, solid-state memories, and optical and magnetic media. Specific examples of machine-readable media 1122 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 1124 may further be transmitted or received over a communications network 1126 using a transmission medium. The instructions 1124 may be transmitted using the network interface device 1120 and any one of a number of well-known transfer protocols (e.g., hypertext transport protocol (HTTP)). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1124 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing, by one or more processors, a first document collection comprising a first file;
based on the first file being an image file, using a trained machine learning model to identify an object depicted in the first file;
copying the first file to a second document collection; and
naming the copy of the first file based on the identified object.

2. The method of claim 1, wherein:
the first document collection comprises a second file; and
the method further comprises:
based on the second file being a text file, using a language embedder to generate a vector representation of contents of the second file;
based on the vector representation of the contents of the second file, identifying a descriptive word for the second file;
copying the second file to the second document collection; and
naming the copy of the second file based on the identified descriptive word.

3. The method of claim 2, further comprising:
based on the identified object depicted in the first file and the descriptive word for the second file, creating link metadata that links the copy of the first file with the copy of the second file.

4. The method of claim 1, further comprising:
based on the first file being an image file, using optical character recognition to identify text depicted in the first file;
using a language embedder to generate a vector representation of the identified text; and
based on the vector representation of the identified text, identifying a descriptive word for the first file;
wherein the naming of the copy of the first file is further based on the identified descriptive word.

5. The method of claim 1, further comprising:
based on metadata for the first file, identifying a creation date of the first file;
wherein the naming of the copy of the first file is further based on the identified creation date.

6. The method of claim 1, wherein:
the copying of the first file to the second document collection is performed as part of copying all files of the first document collection to the second document collection, an order of the copying being based on file sizes of the files of the first document collection.

7. The method of claim 1, wherein:
the naming of the copy of the first file is further based on a name of the first file in the first document collection.

8. The method of claim 7, further comprising:
determining that the name of the first file in the first document collection includes a character in a banned list of characters;
wherein the naming of the copy of the first file comprises excluding the character.

9. The method of claim 1, further comprising:
based on metadata for the first file, identifying a version number of the first file;
wherein the naming of the copy of the first file is further based on the identified version number.

10. A system comprising:
a memory that stores instructions; and
one or more processors configured by the instructions to perform operations comprising:
accessing a first document collection comprising a first file;
based on the first file being an image file, using a trained machine learning model to identify an object depicted in the first file;
copying the first file to a second document collection; and
naming the copy of the first file based on the identified object.

11. The system of claim 10, wherein:
the first document collection comprises a second file; and
the operations further comprise:
based on the second file being a text file, using a language embedder to generate a vector representation of contents of the second file;
based on the vector representation of the contents of the second file, identifying a descriptive word for the second file;
copying the second file to the second document collection; and
naming the copy of the second file based on the identified descriptive word.

12. The system of claim 11, wherein the operations further comprise:
based on the identified object depicted in the first file and the descriptive word for the second file, creating link metadata that links the copy of the first file with the copy of the second file.

13. The system of claim 10, wherein the operations further comprise:
based on the first file being an image file, using optical character recognition to identify text depicted in the first file;
using a language embedder to generate a vector representation of the identified text; and
based on the vector representation of the identified text, identifying a descriptive word for the first file;
wherein the naming of the copy of the first file is further based on the identified descriptive word.

14. The system of claim 10, wherein the operations further comprise:
based on metadata for the first file, identifying a creation date of the first file;
wherein the naming of the copy of the first file is further based on the identified creation date.

15. The system of claim 10, wherein:
the copying of the first file to the second document collection is performed as part of copying all files of the first document collection to the second document collection, an order of the copying being based on file sizes of the files of the first document collection.

16. The system of claim 10, wherein:
the naming of the copy of the first file is further based on a name of the first file in the first document collection.

17. The system of claim 16, wherein the operations further comprise:
determining that the name of the first file in the first document collection includes a character in a banned list of characters;
wherein the naming of the copy of the first file comprises excluding the character.

18. A non-transitory computer-readable medium that stores instructions that, when executed by one or more processors, cause the one or more processors to perform operations comprising:
accessing a first document collection comprising a first file;
based on the first file being an image file, using a trained machine learning model to identify an object depicted in the first file;
copying the first file to a second document collection; and
naming the copy of the first file based on the identified object.

19. The non-transitory computer-readable medium of claim 18, wherein:
the first document collection comprises a second file; and
the operations further comprise:
based on the second file being a text file, using a language embedder to generate a vector representation of contents of the second file;
based on the vector representation of the contents of the second file, identifying a descriptive word for the second file;
copying the second file to the second document collection; and
naming the copy of the second file based on the identified descriptive word.

20. The non-transitory computer-readable medium of claim 19, wherein the operations further comprise:
based on the identified object depicted in the first file and the descriptive word for the second file, creating link metadata that links the copy of the first file with the copy of the second file.
